(19) United States
(12) Patent Application Publication
(10) Pub. No.: US 2022/0119276 A1
(43) Pub. Date: Apr. 21, 2022

(54) WATER TANK ASSEMBLY FOR PURIFYING WATER AND WATER PURIFICATION SYSTEM

(71) Applicant: SUQIAN HANSHU ENVIRONMENTAL PROTECTION EQUIPMENT CO., LTD, NANJING (CN)

(72) Inventors: Guo LIU, NANJING (CN); Xiaohan LIU, NANJING (CN)

(21) Appl. No.: 17/566,697

(22) Filed: Dec. 31, 2021

Related U.S. Application Data
(63) Continuation of application No. PCT/CN2020/127386, filed on Nov. 8, 2020.

(30) Foreign Application Priority Data
Dec. 6, 2019 (CN) 201911245216.3

(51) Int. Cl. C02F 1/00; C02F 1/44; B01D 63/00

(52) U.S. Cl. CPC C02F 1/008; C02F 1/44; B01D 63/00; C02F 2307/10; B01D 2313/18; C02F 2209/42; C02F 2209/40; B01D 2313/50; C02F 2201/005

(57) ABSTRACT

The present application provides a water tank assembly for water purification and a water purification system. The water tank assembly includes: a first water tank, a water inlet guide tube, a water inlet control assembly, a second water tank and a water outlet guide tube. Parameters of the water tank assembly includes a first liquid volume. The first liquid volume is greater than the initiation liquid volume and less than or equal to a level-difference liquid volume. According to the present disclosure, the first cup of water is diluted rapidly to reach the direct-drinking water, ensuring freshness of the direct-drinking water, and allowing the second water tank to take water from the first tank quickly for at least twice.

### CROSS REFERENCE TO RELATED APPLICATIONS

The present application is a continuation-application of International (PCT) Patent Application No. PCT/CN2020/127386, filed on Nov. 8, 2020, which claims foreign priority of Chinese Patent Application No. 201911245216.3, filed on Dec. 6, 2019, in China National Intellectual Property Administration, the entire contents of which are hereby incorporated by reference in their entireties.

### TECHNICAL FIELD

The present disclosure relates to the field of water purification, and in particular to a water tank assembly for water purification and a water purification system.

### BACKGROUND

A water purifier is a domestic kitchen appliance that is commonly used in daily life. The water purifier performs an adsorption process and an isolation process to purify underground water or tap water to obtain water that can be directly drunk.

In the art, the water purifier may generally be configured with a pressure bucket or a tank to store water. When storing the water in the pressure bucket, a pump needs to be configured to provide pressure to an internal air bag to inject the water into the pressure bucket. The air bag may burst easily, and the bucket may not be cleaned and disinfected easily after being used for a long time, water purification may not be achieved effectively. When a built-in water tank is configured for storing the water, a pump and a faucet are required to take the water. Generally, approximately 1.2 liters of pure water may be taken in one minute, causing poorer experience. In addition, in the above two storage techniques, while the water is being taken, new water is replenished into the water purification system at the same time. The techniques do not ensure that the water to be drunk is the freshest water, and a concept of safe drinking cannot be achieved.

A water purifier, which is driven to purify the water by pressure of the tap water, may be energy-saving and environmentally friendly, and may be priority of the industry. Since the pressure of the tap water varies in various households, a direct-flowing water purifier, which takes a high-flux low-pressure membrane to purify the tap water into direct-drinking water, causes the water purification system to produce insufficient water and/or to produce water whose purification quality is not satisfied. In particular, a first cup water may be a problem while using the direct-flowing water purifier, which has an unideal application effect.

### SUMMARY OF THE DISCLOSURE

The present disclosure provides a water tank assembly for water purification, including: a first water tank; a water inlet guide tube, comprising a water outlet end, wherein the water outlet end extends into the first tank; a switch assembly, disposed at the water outlet end and configured to control the water outlet end to be unblocked or blocked; a water inlet control assembly, fixedly connected to the first tank and configured to close the switch assembly to block the water outlet end when a water level in the first tank is detected as being higher than or equal to the first preset level, and to open the switch assembly to unblock the water outlet end when the water level in the first tank is detected as being lower than a second preset level; a second water tank, having an inner bottom wall, wherein the inner bottom wall is disposed at a position lower than an inner bottom wall of the first water tank, a top of the second water tank is at a same level as a top of the first water tank; wherein the second water tank defines a self-locking water inlet hole; the self-locking water inlet hole is cross sectioned by a wall of the second water tank to obtain a highest level point, and the highest level point is lower than the inner bottom wall of the first water tank; the self-locking water inlet hole is unobstructed when sleevedly connected, and is blocked when not sleevedly connected; a water outlet guide tube, disposed between the first water tank and the second water tank, wherein the water outlet guide tube comprises a water inlet end and a self-locking water outlet end; the water inlet end extends through a bottom wall of the first water tank; and the self-locking water outlet end is configured to be unobstructed when sleevedly connected and to be blocked when not sleevedly connected. When the first water tank is in a state of storing a maximum amount of water, and when the second water tank is empty, the water is continuously filled into the second water tank until the water level of the first water tank is equal to the water level of the second water tank, and a sum of a volume of water remained in the first water tank and a volume of water remained in the water inlet control assembly is recorded as a first liquid volume. The first liquid volume is greater than an initiation liquid volume and less than or equal to a level-difference liquid volume. The level-difference liquid volume is a volume of water remained in the water outlet guide tube between the inner bottom wall of the first water tank and the inner bottom wall of the second water tank; and the initiation liquid volume is a volume of the water below the second preset level in the first water tank.

The present disclosure further provides a water purification system, including the above water tank assembly for water purification and an electrical connection member. The electrical connection member is electrically connected to the water tank assembly to supply power for the water tank assembly.

### BRIEF DESCRIPTION OF THE DRAWINGS

FIG. 1 is a structural schematic view of a water tank assembly for water purification according to an embodiment of the present disclosure.

FIG. 2 is a structural schematic view of a water inlet control assembly of a non-electric water tank assembly for water purification according to an embodiment of the present disclosure.

FIG. 3 is a structural schematic view of another water inlet control assembly of a non-electric water tank assembly for water purification according to an embodiment of the present disclosure.

FIG. 4 is a structural schematic view of an electric water tank assembly for water purification according to an embodiment of the present disclosure.

FIG. 5 is a structural schematic view of a stopper at a water outlet port of as water tank assembly for water purification according to an embodiment of the present disclosure.

### DETAILED DESCRIPTION

Specific embodiments of the present disclosure are described in detail hereinafter by referring to the accompanying drawings, but shall not limit the scope of the present disclosure.

It shall be understood that modifications may be made to the embodiments disclosed herein. Therefore, the foregoing specification shall not be interpreted as limiting the present disclosure, but merely as examples of the present disclosure. Any ordinary skilled person in the art shall perform modifications within the scope and spirit of the present disclosure.

The accompanying drawings, which are included in and form a part of the specification, illustrate embodiments of the present disclosure and are combined with the general description of the present disclosure given above and the detailed description of the embodiments given below to explain principles of the present disclosure.

Features of the present disclosure will become apparent from the following description of the preferred form of embodiments given as non-limiting examples by referring to the accompanying drawings.

It shall be understood that although the present disclosure is described with reference to some specific examples, there are many other equivalent forms of the present disclosure that can be implemented with certainty by any ordinary skilled person in the art, which have the features as described in the claims and which therefore all fall within the scope of the present disclosure.

Various aspects, features and advantages of the present disclosure will become more apparent in view of the following detailed description when combined with the accompanying drawings.

Specific embodiments of the present disclosure are described hereinafter with reference to the accompanying drawings. However, it shall be understood that the disclosed embodiments are merely examples of the present disclosure, which may be implemented in a variety of ways. Known and/or repeated functions and structures are not described in detail to avoid unnecessary or redundant details that would render the present disclosure ambiguous. Therefore, specific structural and functional details disclosed herein are not intended to limit the present disclosure, but serve as basis for the claims and representative basis for teaching any ordinary skilled person in the art to perform the present disclosure in substantially any suitable and detailed structure.

The present specification may use terms “in an embodiment,” “in another embodiment,” “in yet another embodiment,” or “in other embodiments. Each of the terms may be used to refer to one or more of the same or different embodiments according to the present disclosure.

The present disclosure provides a water tank assembly for water purification and a water purification system, which will be illustrated in the following embodiments. A first embodiment of the present disclosure is an embodiment of a water tank assembly for water purification.

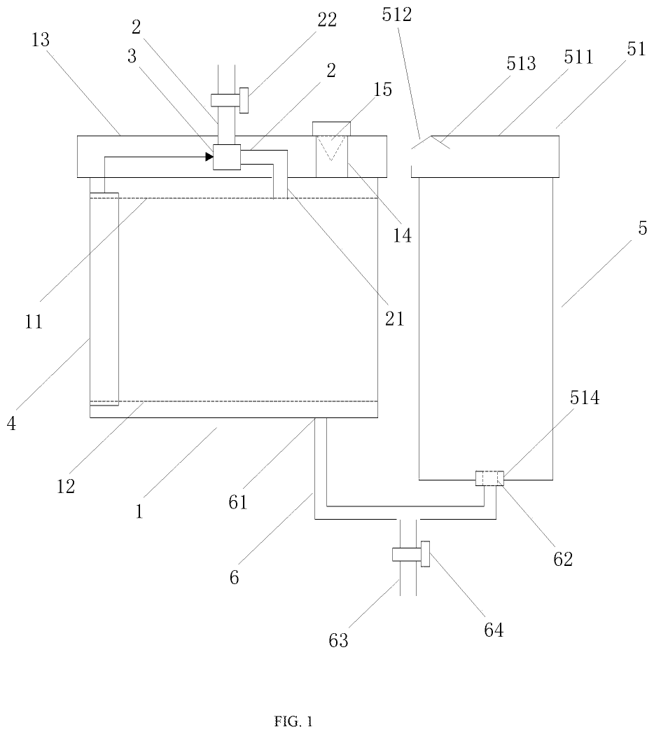

The present embodiment is described in detail below by referring to FIG. 1.

The present embodiment provides a water tank assembly for water purification, which includes: a first water tank 1, a water inlet guide tube 2, a switch assembly 3, a water inlet control assembly 4, a second water tank 5 and a water outlet guide tube 6.

In the present embodiment, the water tank assembly for water purification is configured to solve a problem of direct-drinking water being contaminated by a first cup of water that is generated at a purification and collection end of a purification membrane in a water purification system.

In the present embodiment, a height level difference is present between the first tank 1 and the second tank 5, and the first tank 1 and the second tank 5 are detachably connected. In this way, the second tank 5 may rapidly take purified water from the first tank 1 for at least twice, and the water purification system is initiated to inject purified water into the first tank 1 only when the purified water in the first tank 1 is almost completed taken out. Since the first water tank 1 contains sufficient purified water to dilute the first cup of water generated at the purification and collection end of the purification membrane, quality of the water injected into the first tank 1 is not affected by the first cup of water, ensuring freshness (i.e., the quality) of direct-drinking water, thereby meeting requirements of safe-drinking water.

The water inlet guide tube 2 includes a water outlet end 21, and the water outlet end 21 extends into the first tank 1.

The water inlet guide tube 2 may extend to a position near a bottom of the first tank 1, such that a sound of water running may be reduced.

In an embodiment, the water inlet guide tube 2 further includes a first manual valve 22 disposed out of the first tank 1. The first manual valve 22 is configured to manually control the water inlet guide tube 2. When the first tank 1 has a top cover, and when the water purification system is injecting water, the first manual valve 22 may be closed before opening the top cover to avoid spillage due to the top cover being open.

The switch assembly 3 is disposed at the water outlet end 21 and is configured to control the water outlet end 21 to be open or to be blocked.

The water inlet control assembly 4 is fixedly connected to the first tank 1. The water inlet control assembly 4 is configured to close the switch assembly 3 when a water level in the first tank 1 is higher than or equal to a first preset level 11 and to open the switch assembly 3 when the water level in the first tank 1 is lower than a second preset level 12.

In the first water tank 1, the first preset level 11 is higher than the second preset level 12. For example, the first preset level 11 may be set at a position near the top of the first water tank 1 and the second preset level 12 may be set at a position near the bottom of the first water tank 1. In this way, the amount of the purified water stored in the first water tank 1 may be maximized, allowing the first water tank 1 to output a larger amount of purified water.

The second water tank 5 has an inner bottom wall. The inner bottom wall is disposed at a position lower than an inner bottom wall of the first water tank 1. The top of the second water tank 5 is at a same level as the top of the first water tank 1. It may be understood that, by configuring the top of the second water tank 5 to be at the same level as the top of the first water tank 1, since the two water tanks are fluidly connected through the water outlet guide tube 6, when the water level in the first water tank 1 reaches the first preset level 11, the water levels of the two water tanks are the same, and the water flows into the second water tank 5 will not overflow out of the second water tank 5. Appropriate elevation of any one of the two tanks in height is also included in the scope of the present disclosure.

The second water tank 5 defines a self-locking water inlet hole 514. The self-locking water inlet hole 514 may be cross sectioned by a wall of the second water tank 5 to obtain a highest level point, and the highest level point is lower than the inner bottom wall of the first water tank 1. In this way, a height level difference is present between the first water tank 1 and the second water tank 2, and the height level difference allows the water in the first water tank 1 to flow into the second water tank 2 at all times. The self-locking water inlet hole 514 may be unobstructed when sleeving the water outlet guide tube 6 and may be blocked when not sleeving the water outlet guide tube 6. When the second water tank 5 is used alone, the self-locking water inlet hole 514 is blocked, such that the water in the second water tank 5 does not flow out. When the second water tank 5 is fluidly connected to the first water tank 1, the self-locking water inlet hole 514 is unobstructed, such that the water in the first water tank 1 may flow into the second water tank 5.

In an embodiment, a top of the second water tank 5 is covered by a third top cover 51. The third top cover 51 is detachably connected to the second water tank 5.

The third top cover 51 includes: a third cover plate 511, a third water outlet port 512 and an outlet stopper 513.

The third water outlet port 512 extends through the third cover plate 511.

The outlet stopper 513 is pivotably connected to the third cover plate 511. The outlet stopper 513 is configured to cover the third water outlet port 512 when the second water tank 5 is placed horizontally and to allow the water in the second water tank 5 to flow out of the tank through the third water outlet port 512 when the second water tank 5 is tilted.

As shown in FIG. 5, in an embodiment, the outlet stopper 513 includes: a first stopper 5131, a second stopper 5132 and a rotation shaft 5133. Each of the first stopper 5131 and the second stopper 5132 is fixedly connected to the rotation shaft 5133. The rotation shaft 5133 is rotatably connected to the third cover plate 511. The first stopper 5131 is disposed at the third water outlet port 512, and the second stopper 5132 extends into the second water tank 5. A weight of the first stopper 5131 is equal to a weight of the second stopper 5132. In this way, when the second water tank 5 is placed horizontally, the first stopper 5131 covers the third water outlet port 512, and when the second water tank 5 is tilted, the water in the second water tank 5 may flow out of the tank through the third water outlet port 512.

In an embodiment, an angle between the first stopper 5131 and the second stopper 5132 is greater than or equal to 90 degrees. The first stopper 5131 may be a solid stopper, and the second stopper 5132 may be a hollow stopper. For example, the second stopper 5132 is a frame structure. When the second water tank 5 is pouring water, due to the gravity, the second water tank 5 may be tilted at most 45 degrees to allow the outlet stopper 513 to completely unblock the third water outlet port 512, and the water in the second water tank 5 may flow through the hollow stopper out of the tank. The outlet stopper 513 can effectively block any floating suspended matter in the air. In a process of purifying and taking water, the water in the first water tank 1 quickly flows into the second water tank 5, compressing gas in the second water tank 5, and the outlet stopper 513 may be easily pushed to unblock the water outlet port to allow the gas to escape.

The water outlet guide tube 6 is disposed between the first water tank 1 and the second water tank 5. The water outlet guide tube 6 includes a water inlet end 61 and a self-locking water outlet end 62. The water inlet end 61 extends through a bottom wall of the first water tank 1. The self-locking water outlet end 62 is configured to be unobstructed when being sleeved and to be blocked when being not sleeved. The self-locking water inlet hole 514 may sleeve the self-locking water outlet end 62 in a detachably manner.

In an embodiment, in order to remove the water from the first water tank 1 when taking water from the first water tank 1, a drain 63 is fluidly connected to a lower point of the water outlet guide tube 6. The drain 63 includes a second manual valve 64.

When the self-locking water inlet hole 514 is not sleevedly connected to the self-locking water outlet end 62, the water in the first water tank 1 does not flow out of the tank. When the self-locking water inlet hole 514 is sleevedly connected to the self-locking water outlet end 62, the water in the first water tank 1 flows into the second water tank 5.

According to water tank assembly for water purification provided in the embodiments of the present disclosure, the first cup of water may be quickly diluted, the quality of the water in the tank may reach quality of the direct-drinking water, ensuring the direct-drinking water to be fresh, and the second water tank 5 may quickly take the purified water from the first water tank 1 for at least twice.

Therefore, the water tank assembly for water purification may have the following features.

When the first water tank 1 is in a state of storing a maximum amount of water, and when the second water tank 5 is empty, the water is continuously filled into the second water tank 5 until the water level of the first water tank 1 is equal to the water level of the second water tank 5, and a sum of a volume of water remained in the first water tank 1 and a volume of water remained in the water inlet control assembly 4 is recorded as a first liquid volume.

The first liquid volume is greater than an initiation liquid volume and less than or equal to a level-difference liquid volume.

The level-difference liquid volume is a volume of water remained in the water outlet guide tube 6 between the inner bottom wall of the first water tank 1 and the inner bottom wall of the second water tank 5.

The initiation liquid volume is a volume of the water below the second preset level 12 in the first water tank 1.

When the water purification system is shut down, the second water tank 5 in a connected state may be taken out, and the direct-drinking water may be poured out of the second water tank 5. The water in the second water tank 5 may be completely poured out at once or in several times, such that the water may be taken out quickly and as the user wishes. When water in the second water tank 5 is completely poured out, the second tank 5 may be connected again. In this case, the purified water in the first water tank 1 may be quickly injected into the second water tank 5 due to the height level difference between the two tanks. In order to allow the water to be injected quickly enough, the water outlet guide tube 6 may be a high flux guide tube.

After the water levels of the two water tanks are equal, the initiation liquid volume is less than the first liquid volume, the water purification system is not initiated for water purification. When the second water tank 5 is taken out at a second time and the direct-drinking water in the second water tank 5 is completely poured out, the second water tank 5 is fluidly connected to first water tank 1, the remaining purified water in the first water tank 1 may continue to flow to the second water tank 5.

The water purification system may be initiated for water purification, i.e., water is output to the first water tank 1, when the water level in the first water tank 1 is lower than the second preset level 12. The first cup of liquid containing a high amount of dissolved solids is diluted by the purified water in the first liquid volume. When the user urgently needs water and takes the second water tank 5 at this moment, due to the first liquid volume being sufficient, the quick access to the water may not be affected by the first cup of water. At the same time, the water in the first water tank 1 is the made freshly. In this way, advantages of the direct-flowing water purifier are maintained, a high cost of the direct-flowing water purifier may be avoided, and the problem of the first cup of water caused by the large flux membrane may be avoided.

Further, the first liquid volume is greater than or equal to a limiting liquid volume and less than or equal to the level-difference liquid volume. The limiting liquid volume is greater than the initiation liquid volume and less than the level-difference liquid volume.

When the water purification system is just initiated, an amount of the dissolved solids contained in the first cup of water generated at the purification and collection end of the membrane is significantly greater than that contained in the water that is produced normally. The first cup of water is bitter and is unqualified. By performing a test, at least 500 ml of normal water is required to effectively dilute the first cup of water to solve the quality problem. However, due to the water quality being various in various regions, a type of membrane, a flux of the membrane, and a desalination rate may vary. Further, a time length that the water purification system stops making water may also affect a TDS value of the first cup of water produced by the water purification system. Therefore, a higher volume of the purified water for dilution may be desired.

Further, when the initiation liquid volume is less than 500 ml, the limiting liquid volume is greater than or equal to 500 ml and less than the level-difference liquid volume.

In order to allow the second water tank 5 to be fluidly connected to the first water tank 1 again when some water is still stored in the second water tank 5, further, in a case of a volume of the second water tank 5 being unchanged, the first liquid volume is greater than or equal to the limiting liquid volume and less than or equal to a half of the level-difference liquid volume.

Due to a situation of the first water tank 1 being fluidly connected to the second water tank 5 for a plurality of times, the level-difference liquid volume may be increased to effectively reduce a possibility of the two tanks being fluidly connected for a plurality of times, and to avoid the level of the water stored in the first water tank 1 from being uncontrollable due to the water levels of the two tanks being balanced for a plurality of times. By increasing the level-difference liquid volume, the purified water stored in the first water tank 1 may flow quickly to the second water tank 5, and at the same time, new purified water may not be injected into the first water tank 1 until the water level in the first water tank 1 is below the second preset level 12.

In an embodiment, to ensure water safety, a surface of any part of the water tank assembly that contacts the water is coated with an antimicrobial layer. For example, the antimicrobial layer may be a nano-silver layer.

According to the embodiments of the present disclosure, the first water tank 1 is detachably connected to the second water tank 5, the water purifier placed in the kitchen may be thin and small-sized. At the same time, the volume of the tank is large enough to store enough water, meeting water demands, and allowing the first cup of water to be effectively diluted.

The second water tank 5 may be quickly filled with enough water to meet needs of taking water (using water) quickly. According to the setting, the first water tank 1 may quickly release the water to meet needs of storing water (injecting the water in the second water tank 5) quickly.

When the second water tank 5 is taking water quickly, the water purification system may be prevented from initiating for a plurality of times to make the purified water. Since the first water tank 1 does not store the water, the drinking water taken each time is freshly made.

In this way, the problem of water storage caused by taking water through the faucet from an independent water tank may be solved.

In the present disclosure, combination of a water tank, a pump and a faucet for taking water may be omitted, significantly reducing a production cost and achieving a water purifier that has a small flux but providing an extra-large flux water taken. The present disclosure may be applied for any kitchen water purifier, which is a preferred replacement of the water purifier in the art.

When the first water tank 1 is rectangular, enough water may be stored, and a body of the water tank may be thin and small sized. The second water tank 5 is cylindrical, avoiding an orientation problem while placing the second water tank 5 and facilitating the water to be poured out.

For households, the water purifier may be installed in the kitchen. Since the kitchen is a place where electronic appliances are concentratedly occupied, a shortage of power sockets may limit the application of the water purifier.

Therefore, the present disclosure further provides a non-electric water tank assembly for water purification, solving the problem of the shortage of power sockets limiting the application of the water purifier.

Based on the embodiments of the water tank assembly for water purification as described above, the switch assembly 3 in the non-electric water tank assembly for water purification of the present embodiment includes a first valve body 31.

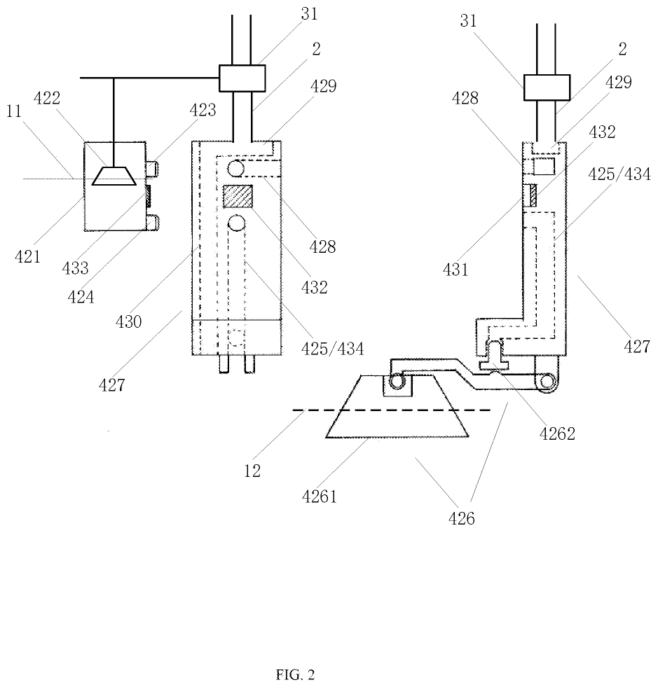

As shown in FIG. 2, the water inlet control assembly 4 includes: a first tank control cabin 421, a first float 422, a first upper horizontal flow tube 423, a first lower horizontal flow tube 424, a first longitudinal guide tube 425 and a second float valve 426.

The first tank control cabin 421 is disposed at an upper end of the first water tank 1, and a bottom of an inner side wall of the first tank control cabin 421 is higher than the second preset level 12.

The first float 422 is disposed inside the first tank control cabin 421. The first float 422 and the first valve body 31 cooperatively serve as a first self-locking float valve. The first float 422 is configured to control the first valve body 31 to block the water outlet end 21 when the water level in the first water tank 1 is higher than or equal to the first preset level 11, and to control the first valve body 31 to unblock the water outlet end 21 when the water level in the first tank control cabin 421 is below the first preset level 11.

The first upper horizontal flow tube 423 is fluidly connected to the first tank control cabin 421 and the first water tank 1. A lowest point of a cross section of the first upper horizontal flow tube 423 is higher than or equal to the first preset level 11. In this way, when the water outlet end 21 is unblocked, the water in the first water tank 1 flows into the first tank control cabin 421.

An end of the first lower horizontal flow tube 424 is connected to the bottom of the inner side wall of the first tank control cabin 421.

The first longitudinal guide tube 425 is disposed inside the first water tank 1. An end of the first longitudinal guide tube 425 is connected the other end of the first lower horizontal flow tube 424. The other end of the first longitudinal guide tube 425 extends toward the inner bottom wall of the first water tank 1.

The second float valve 426 is disposed inside the first water tank 1 at a position near the second preset level 12 and includes a second float 4261 and a second valve body 4262. The second valve body 4262 is arranged at the other end of the first longitudinal guide tube 425. The second float 4261 is configured to control the second valve body 4262 to unblock the first longitudinal guide tube 425 when the water level in the first water tank 1 is detected as being lower than the second preset level 12, and to control the second valve body 4262 to block the first longitudinal guide tube 425 when the water level in the first water tank 1 is detected as being higher than or equal to the second preset level 12.

The present embodiment avoids a situation that, when taking water from the independent water tank quickly, the water level in the tank control cabin liquid level changes, resulting in the self-locking float valve to release pressures to cause the water purification system to misoperate, which may break the set cycle control and affect water quality.

The present embodiment further avoids a water storage problem while taking water from the independent tank through the faucet, especially the present embodiment further avoids the problem that the water quality may be affected due to the water stored in the tank control cabin being uncontrollable, which may affect the control of the cycle between the tank control cabin and the first water tank 1.

FIG. 2 is a structural schematic view of the water inlet control assembly of a non-electronic water tank assembly for water purification according to an embodiment of the present disclosure. In the present embodiment, the first water tank control cabin 421 is disposed inside the first water tank 1.

The top of the first water tank control cabin 421 may be lower than the top of the first water tank 1, and the bottom of the first water tank control cabin 421 is higher than the second preset level 12.

In an embodiment, the top of the first water tank control cabin 421 is at the same level as the top of the first water tank 1.

A first top cover 13 is arranged to cover the top of the first water tank 1 and the top of the first water tank control cabin 421.

The first valve body 31 is disposed in the first top cover 13, preventing secondary contamination of the water in the first water tank 1 caused by the first valve body 31.

The first top cover 13 defines a first ventilation hole 14, and a first air filtration component 15 is disposed in the first ventilation hole 14. The first air filtration component 15 has a filtering sterilization effect. The first ventilation hole 14 ensures ventilation in the first water tank 1, such that the purified water in the first water tank 1 may flow rapidly.

The water inlet control assembly 4 further includes a flow guiding block 427 fixedly connected to the inner side wall of the first water tank 1. The flow guiding block 427 includes a first longitudinal guiding channel 434 extending through the flow guiding block 427. The first longitudinal guiding channel 434 is a first longitudinal guiding tube 425.

The flow guiding block 427 further includes a sound dissipation slot 429 and a sound dissipation channel 430.

The sound dissipation slot 429 is defined at a top of the flow guiding block 427. The water outlet end 21 extends into the sound dissipation slot 429.

In an embodiment, the sound dissipation slot 429 is sealed to the water outlet end 21, preventing splashing instantaneously while the first self-locking float valve is releasing the pressure. An end of the sound dissipation channel 430 is connected to a bottom of the sound dissipation slot 429, and the other end the sound dissipation channel 430 extends along with the flow guiding block 427 to reach an upper part of the second preset level 12 of the first water tank 1. In this way, the sound of water running may be reduced.

A port of an end of the first longitudinal guiding channel 434 is sealed to the first lower horizontal flow tube 424.

The flow guiding block 427 further includes a horizontal channel 428 extending through the flow guiding block 427. A port of an end of the horizontal channel 428 is fluidly connected to the first water tank 1, and a port of the other end of the horizontal channel 428 is sealed to the first upper horizontal flow tube 423.

The flow guiding block 427 further includes a recess 431 and a first magnet 432. The first magnet 432 is received in the recess 431. The first tank control cabin 421 further includes a second magnet 433 disposed on an outer side wall of the first tank control cabin 421. The first magnet 432 works with the second magnet 433 cooperatively to magnetically connect the flow guiding block 427 to the first tank control cabin 421.

A cross section of a connection port between the first upper horizontal flow tube 423 and the first tank control cabin 421 and a cross section of a connection port between the first lower horizontal flow tube 424 and the first tank control cabin 421 are located on a same vertical line.

The second magnet 433 is disposed between the first upper horizontal flow tube 423 and the first lower horizontal flow tube 424.

A sleeving end of the horizontal channel 428 is located on a same vertical line as a sleeving end of the first longitudinal guiding channel 434.

The first magnet 432 is disposed between the sleeving end of the horizontal channel 428 and the sleeving end of the first longitudinal guiding channel 434.

The first tank control cabin 421 is connected to the flow guiding block 427 by magnetic connection, by being sleeved and sealed to the first upper horizontal flow tube 423, and by being sleeved and sealed to the first lower horizontal flow tube 424. In this way, the first water tank 1 and the first tank control cabin 421 may be connected and fixed quickly, and may be easily disassembled and cleaned, preventing the problem that the float valve is not installed in a proper place, causing the water purification system to be unable to automatically circulate.

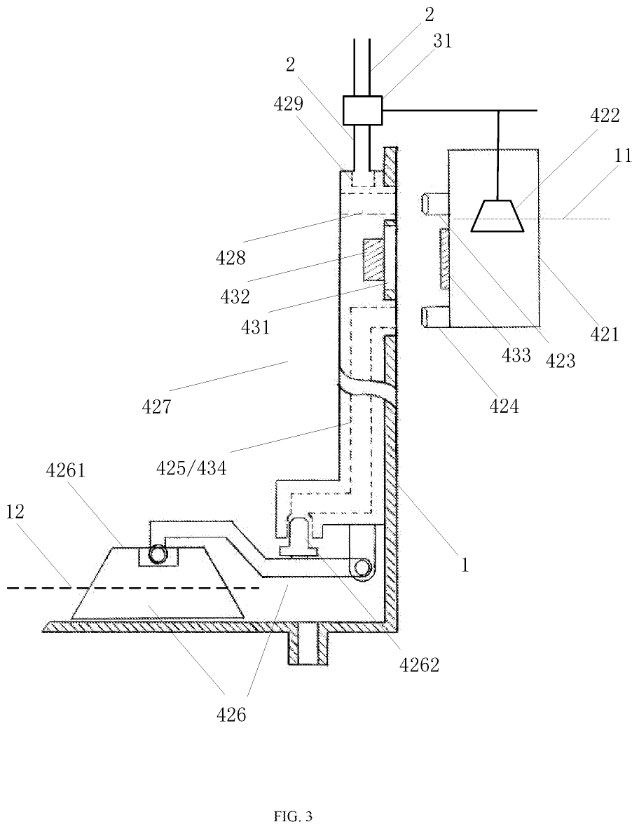

FIG. 3 is a structural schematic view of another water inlet control assembly of a non-electric water tank assembly for water purification according to an embodiment of the present disclosure.

In the present embodiment, the first water tank control cabin 421 is disposed outside the first water tank 1.

The top of the first water tank control cabin 421 may be lower than the top of the first water tank 1, and the bottom of the first water tank control cabin 421 is higher than the second preset level 12.

In an embodiment, the top of the first water tank control cabin 421 is at the same level as the top of the first water tank 1.

The first top cover 13 is arranged to cover the top of the first water tank 1 and the top of the first tank control cabin 421.

The first valve body 31 is disposed inside the first top cover 13, preventing secondary contamination of the water in the first water tank 1 caused by the first valve body 31.

The first top cover 13 defines the first ventilation hole 14. The first air filtration component 15 is disposed inside the first ventilation hole 14. The first air filtration component 15 has a filter sterilization effect. The first ventilation hole 14 ensures ventilation in the first water tank 1, such that the water in the first water tank 1 may flow rapidly.

The water inlet control assembly 4 further includes a flow guiding block 427 fixedly connected to the inner side wall of the first water tank 1. The flow guiding block 427 includes the first longitudinal guiding channel 434 extending through the flow guiding block 427. The first longitudinal guiding channel 434 is the first longitudinal guiding tube 425.

The flow guiding block 427 further includes a sound dissipation slot 429 and a sound dissipation channel 430.

The sound dissipation slot 429 is defined in the top of the flow guiding block 427. The water outlet end 21 extends into the sound dissipation slot 429.

In an embodiment, the sound dissipation slot 429 is sealed to the water outlet end 21, preventing splashing instantaneously while the first self-locking float valve is releasing the pressure.

An end of the sound dissipation channel 430 is connected to the bottom of the sound dissipation slot 429, and the other end of the sound dissipation channel 430 extends along with the flow guiding block 427 to reach the upper part of the second preset level 12 of the first water tank 1. In this way, the sound of water running can be reduced.

A port of an end of the first longitudinal guiding channel 434 is sealed and sleeved to the first lower horizontal flow tube 424.

The flow guiding block 427 further includes a horizontal channel 428 extending through the flow guiding block 427. A port of an end of the horizontal channel 428 is fluidly connected to the first water tank 1, and a port of the other end of the horizontal channel 428 is sealed and sleeved to the first upper horizontal flow tube 423.

The flow guiding block 427 further includes a recess 431 and a first magnet 432. The first magnet 432 is received in the recess 431. The first tank control cabin 421 further includes a second magnet 433 disposed on an outer side wall of the first tank control cabin 421. The first magnet 432 works with the second magnet 433 cooperatively to magnetically connect the flow guiding block 427 to the first tank control cabin 421.

A cross section of a connection port between the first upper horizontal flow tube 423 and the first tank control cabin 421 and a cross section of a connection port between the first lower horizontal flow tube 424 and the first tank control cabin 421 are located on a same vertical line.

The second magnet 433 is disposed between the first upper horizontal flow tube 423 and the first lower horizontal flow tube 424.

A sleeving end of the horizontal channel 428 is located on a same vertical line as a sleeving end of the first longitudinal guiding channel 434.

The first magnet 432 is disposed between the sleeving end of the horizontal channel 428 and the sleeving end of the first longitudinal guiding channel 434.

The first tank control cabin 421 is connected to the flow guiding block 427 by magnetic connection, by being sleeved and sealed to the first upper horizontal flow tube 423, and by being sleeved and sealed to the first lower horizontal flow tube 424. In this way, the first water tank 1 and the first tank control cabin 421 may be connected and fixed quickly, and may be easily disassembled and cleaned, preventing the problem that the float valve is not installed in a proper place, causing the water purification system to be unable to automatically circulate. Since the first tank control cabin 421 is disposed out of the first water tank 1, reducing the possibility that the purified water is contaminated.

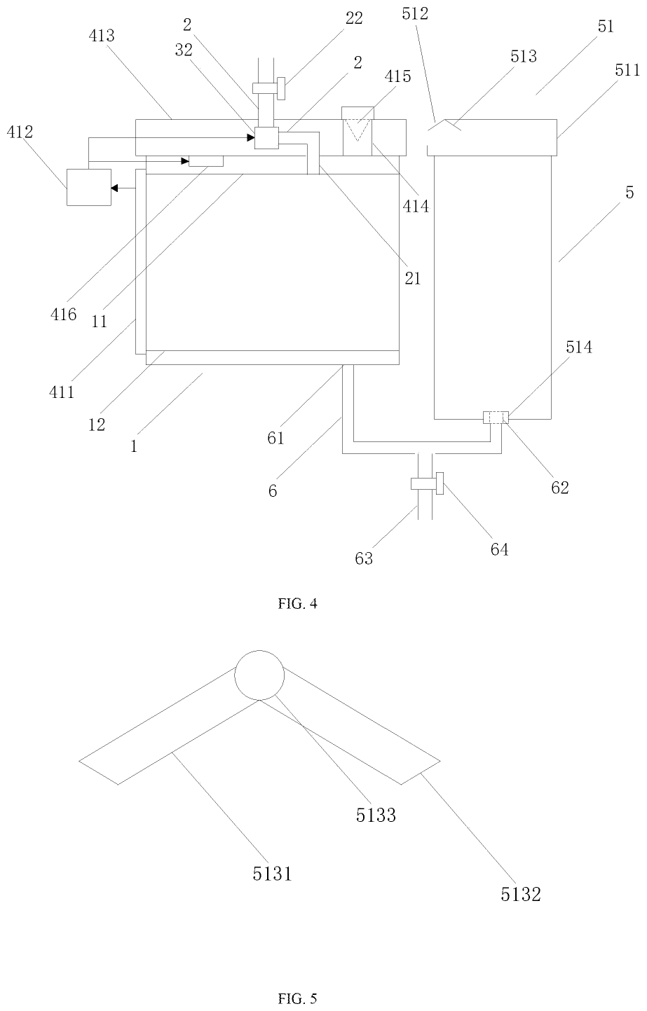

The present disclosure further provides an electronic water tank assembly for water purification. The electronic water tank assembly for water purification is configured to be electrically connected to an electrical connection member. The electrical connection member is configured to supply power to the electronic water tank assembly for water purification. For example, FIG. 4 is a structural schematic view of an electric water tank assembly for water purification according to an embodiment of the present disclosure. In the present embodiment, the electrical connection member includes a conducting wire. One end of the conducting wire is connected to the water tank assembly, and the other end of the conducting wire is connected to a power source to allow the power source to supply power to the water tank assembly. In some embodiments, the electrical connection member may further include a removable battery, and the removable battery supplies power to the water tank assembly.

In the present embodiment, the switch assembly 3 includes a water inlet electromagnetic valve 32.

The water inlet control assembly 4 includes: a liquid level sensor 411 and a processor 412.

The liquid level sensor 411 is disposed on the side wall of the first water tank 1.

In order to avoid signal lines when cleaning the first water tank 1, in an embodiment, the liquid level sensor 411 is a non-contact liquid level sensor 411, disposed on the outer side wall of the first water tank 1.

The processor 412 is disposed outside the first water tank 1 and is communicatively connected to the liquid level sensor 411. The processor 412 is configured to receive a water level signal sent from the liquid level sensor 411. When the water level signal indicates the water level is higher than or equal to the first preset level 11, the processor 412 controls the water inlet magnetic valve 32 to block the water outlet end 21. When the water level signal indicates the water level is lower than the second preset level 12, the processor 412 controls the water inlet magnetic valve 32 to unblock the water outlet end 21. To be noted that, in the present embodiment, when the second preset level 12 is set near the inlet end 61 of the water outlet guide tube 6 connected to the bottom of the first water tank 1, a same implementation effect may be achieved, and the situation shall be interpreted as an equivalent replacement of the present disclosure.

The top of the first water tank 1 is capped by a second top cover 413. The second top cover 413 defines a second ventilation hole 414. A second air filtration assembly 415 is disposed in the second ventilation hole 414. The second air filtration assembly 415 has a filtering and sterilizing effect. The second ventilation hole 414 ensures ventilation in the first water tank 1, such that the purified water in the first water tank 1 flows rapidly.

A bottom of the second top cover 413 in the first water tank 1 is configured with an electric sterilization device 416. The electric sterilization device 416 and the processor 412 are communicatively connected. The electric sterilization device 416 may extend time for using the first water tank 1 before cleaning.

In order to provide a concise description, relevant portions of the present embodiment may be found in the corresponding descriptions of the other embodiments in the above.

The present disclosure further provides a water purification system. The water purification system includes the water tank assembly for water purification described in any of the above embodiments and an electrical connection member. The electrical connection member is electrically connected to the water tank assembly to supply power to the water tank assembly.

The above embodiments are only exemplary embodiments of the present disclosure and are not intended to limit the present disclosure. The scope of the present disclosure is limited by the claims. Any ordinary skilled person in the art may make various modifications or equivalent substitutions to the embodiments within the scope of the present disclosure. Such modifications or equivalent substitutions shall be interpreted as falling within the scope of the present disclosure.

What is claimed is:

1. A water tank assembly for water purification, comprising:
a first water tank;
a water inlet guide tube, comprising a water outlet end, wherein the water outlet end extends into the first tank;
a switch assembly, disposed at the water outlet end and configured to control the water outlet end to be unblocked or blocked;
a water inlet control assembly, fixedly connected to the first tank and configured to close the switch assembly to block the water outlet end when a water level in the first tank is detected as being higher than or equal to the first preset level, and to open the switch assembly to unblock the water outlet end when the water level in the first tank is detected as being lower than a second preset level;
a second water tank, having an inner bottom wall, wherein the inner bottom wall is disposed at a position lower than an inner bottom wall of the first water tank, a top of the second water tank is at a same level as a top of the first water tank; wherein the second water tank defines a self-locking water inlet hole; the self-locking water inlet hole is cross sectioned by a wall of the second water tank to obtain a highest level point, and the highest level point is lower than the inner bottom wall of the first water tank; the self-locking water inlet hole is unobstructed when sleevedly connected, and is blocked when not sleevedly connected;
a water outlet guide tube, disposed between the first water tank and the second water tank, wherein the water outlet guide tube comprises a water inlet end and a self-locking water outlet end; the water inlet end extends through a bottom wall of the first water tank;
and the self-locking water outlet end is configured to be unobstructed when sleevedly connected and to be blocked when not sleevedly connected;
wherein when the first water tank is in a state of storing a maximum amount of water, and when the second water tank is empty, the water is continuously filled into the second water tank until the water level of the first water tank is equal to the water level of the second water tank, and a sum of a volume of water remained in the first water tank and a volume of water remained in the water inlet control assembly is recorded as a first liquid volume;
the first liquid volume is greater than an initiation liquid volume and less than or equal to a level-difference liquid volume;
the level-difference liquid volume is a volume of water remained in the water outlet guide tube between the inner bottom wall of the first water tank and the inner bottom wall of the second water tank; and the initiation liquid volume is a volume of the water below the second preset level in the first water tank.

2. The water tank assembly for water purification according to claim 1, wherein the switch assembly comprises a first valve body, and the water inlet control assembly comprises:
a first tank control cabin, disposed at an upper end of the first water tank, wherein a bottom of an inner side wall of the first tank control cabin is higher than the second preset level;
a first float, disposed inside the first tank control cabin, wherein the first float and the first valve body cooperatively serve as a first self-locking float valve, the first float is configured to control the first valve body to block the water outlet end when the water level in the first water tank is detected as being higher than or equal to the first preset level, and to control the first valve body to unblock the water outlet end when the water level in the first tank control cabin is detected as being below the first preset level;
a first upper horizontal flow tube, fluidly connected to the first tank control cabin and the first water tank, a lowest point of a cross section of the first upper horizontal flow tube is higher than or equal to the first preset level, allowing the water in the first water tank to flow into the first tank control cabin when the water outlet end is unblocked;
a first lower horizontal flow tube, wherein an end of the first lower horizontal flow tube is connected to a bottom of the inner side wall of the first tank control cabin;
a first longitudinal guide tube, disposed inside the first water tank, wherein an end of the first longitudinal guide tube is connected the other end of the first lower horizontal flow tube, and the other end of the first longitudinal guide tube extends toward the inner bottom wall of the first water tank;
a second float valve, disposed inside the first water tank at a position near the second preset level and comprising a second float and a second valve body, wherein the second valve body is arranged at the other end of the first longitudinal guide tube; the second float is configured to control the second valve body to unblock the first longitudinal guide tube when the water level in the first water tank is detected as being lower than the second preset level, and to control the second valve body to block the first longitudinal guide tube when the water level in the first water tank is detected as being higher than or equal to the second preset level.

3. The water tank assembly for water purification according to claim 2, wherein the water inlet control assembly further comprises a flow guiding block fixedly connected to the inner side wall of the first water tank, the flow guiding block comprises a first longitudinal guiding channel extending through the flow guiding block.

4. The water tank assembly for water purification according to claim 3, wherein the flow guiding block further comprises a sound dissipation slot and a sound dissipation channel;
the sound dissipation slot is defined at a top of the flow guiding block, and the water outlet end extends into the sound dissipation slot; and
an end of the sound dissipation channel is connected to a bottom of the sound dissipation slot, and the other end of the sound dissipation channel extends along with the flow guiding block to reach an upper part of the second preset level of the first water tank.

5. The water tank assembly for water purification according to claim 3, wherein a port of an end of the first longitudinal guiding channel is sealed and sleeved to the first lower horizontal flow tube.

6. The water tank assembly for water purification according to claim 5, wherein the flow guiding block further comprises a horizontal channel extending through the flow guiding block, a port of an end of the horizontal channel is fluidly connected to the first water tank, and a port of the other end of the horizontal channel is sealed and sleeved to the first upper horizontal flow tube.

7. The water tank assembly for water purification according to claim 6, wherein the flow guiding block further comprises a recess and a first magnet; the first magnet is received in the recess; the first tank control cabin further comprises a second magnet disposed on an outer side wall of the first tank control cabin; the first magnet works with the second magnet cooperatively to magnetically connect the flow guiding block to the first tank control cabin.

8. The water tank assembly for water purification according to claim 7, wherein a cross section of a connection port between the first upper horizontal flow tube and the first tank control cabin and a cross section of a connection port between the first lower horizontal flow tube and the first tank control cabin are located on a same vertical line.

9. The water tank assembly for water purification according to claim 8, wherein a sleeving end of the horizontal channel is located on a same vertical line as a sleeving end of the first longitudinal guiding channel.

10. The water tank assembly for water purification according to claim 1, wherein a top of the first water tank control cabin is at the same level as a top of the first water tank;
a first top cover is arranged to cover the top of the first water tank and the top of the first water tank control cabin; and
a first valve body is disposed in the first top cover.

11. The water tank assembly for water purification according to claim 10, wherein the first top cover defines a first ventilation hole, and a first air filtration component is disposed in the first ventilation hole.

12. The water tank assembly for water purification according to claim 1, wherein the water inlet control assembly comprises:
a liquid level sensor, disposed on the side wall of the first water tank;
a processor, disposed outside the first water tank and communicatively connected to the liquid level sensor, wherein the processor is configured to receive a water level signal sent from the liquid level sensor; when the water level signal indicates that the water level is higher than or equal to the first preset level, the processor is configured to control the switch assembly to block the water outlet end; and when the water level signal indicates that the water level is lower than the second preset level, the processor is configured to control the switch assembly to unblock the water outlet end.

13. The water tank assembly for water purification according to claim 10, wherein the top of the first water tank is capped by a second top cover; the second top cover defines a second ventilation hole, and a second air filtration assembly is disposed in the second ventilation hole.

14. The water tank assembly for water purification according to claim 1, wherein the water inlet guide tube further comprises a first manual valve disposed out of the first water tank; and a drain is fluidly connected to a lower point of the water outlet guide tube, the drain comprises a second manual valve.

15. The water tank assembly for water purification according to claim 1, wherein a top of the second water tank is covered by a third top cover, the third top cover is detachably connected to the second water tank, and the third top cover comprises:
a third cover plate;
a third water outlet port, extending through the third cover plate;
an outlet stopper, is pivotably connected to the third cover plate, wherein the outlet stopper is configured to cover the third water outlet port when the second water tank is placed horizontally and to allow the water in the second water tank to flow out of the second water tank through the third water outlet port when the second water tank is tilted.

16. The water tank assembly for water purification according to claim 15, wherein the outlet stopper comprises: a first stopper, a second stopper and a rotation shaft;
each of the first stopper and the second stopper is fixedly connected to the rotation shaft, the rotation shaft is rotatably connected to the third cover plate;
the first stopper is disposed at the third water outlet port, and the second stopper extends into the second water tank;
a weight of the first stopper is equal to a weight of the second stopper;
when the second water tank is placed horizontally, the first stopper covers the third water outlet port, and when the second water tank is tilted, the first stopper allows the water in the second water tank to flow out of the second water tank through the third water outlet port.

17. The water tank assembly for water purification according to claim 1, wherein the first liquid volume is greater than or equal to a limiting liquid volume and less than or equal to the level-difference liquid volume; and the limiting liquid volume is greater than the initiation liquid volume and less than the level-difference liquid volume.

18. The water tank assembly for water purification according to claim 17, wherein when the initiation liquid volume is less than 500 ml, the limiting liquid volume is greater than or equal to 500 ml and less than the level-difference liquid volume.

19. The water tank assembly for water purification according to claim 18, wherein when a volume of the second water tank is unchanged, the first liquid volume is greater than or equal to the limiting liquid volume and less than or equal to a half of the level-difference liquid volume.

20. A water purification system, comprising a water tank assembly and an electrical connection member, wherein the electrical connection member is electrically connected to the water tank assembly for supplying power to the water tank assembly, and the water tank assembly comprises:
a first water tank;
a water inlet guide tube, comprising a water outlet end, wherein the water outlet end extends into the first tank;
a switch assembly, disposed at the water outlet end and configured to control the water outlet end to be unblocked or blocked;
a water inlet control assembly, fixedly connected to the first tank and configured to close the switch assembly to block the water outlet end when a water level in the first tank is detected as being higher than or equal to the first preset level, and to open the switch assembly to unblock the water outlet end when the water level in the first tank is detected as being lower than a second preset level;
a second water tank, having an inner bottom wall, wherein the inner bottom wall is disposed at a position lower than an inner bottom wall of the first water tank, a top of the second water tank is at a same level as a top of the first water tank; wherein the second water tank defines a self-locking water inlet hole; the self-locking water inlet hole is cross sectioned by a wall of the second water tank to obtain a highest level point, and the highest level point is lower than the inner bottom wall of the first water tank; the self-locking water inlet hole is unobstructed when sleevedly connected, and is blocked when not sleevedly connected;
a water outlet guide tube, disposed between the first water tank and the second water tank, wherein the water outlet guide tube comprises a water inlet end and a self-locking water outlet end; the water inlet end extends through a bottom wall of the first water tank; and the self-locking water outlet end is configured to be unobstructed when sleevedly connected and to be blocked when not sleevedly connected;
wherein when the first water tank is in a state of storing a maximum amount of water, and when the second water tank is empty, the water is continuously filled into the second water tank until the water level of the first water tank is equal to the water level of the second water tank, and a sum of a volume of water remained in the first water tank and a volume of water remained in the water inlet control assembly is recorded as a first liquid volume;
the first liquid volume is greater than an initiation liquid volume and less than or equal to a level-difference liquid volume;
the level-difference liquid volume is a volume of water remained in the water outlet guide tube between the inner bottom wall of the first water tank and the inner bottom wall of the second water tank; and the initiation liquid volume is a volume of the water below the second preset level in the first water tank.
